(19) United States
(12) Patent Application Publication
(10) Pub. No.: US 2024/0091967 A1
(43) Pub. Date: Mar. 21, 2024

(54) RAZOR HANDLE

(71) Applicant: DORCO CO., LTD., Yongin-si (KR)

(72) Inventors: Sang Hun PARK, Seoul (KR); Su Hyun CHAE, Seoul (KR)

(21) Appl. No.: 18/508,677

(22) Filed: Nov. 14, 2023

Related U.S. Application Data
(63) Continuation of application No. PCT/KR2022/005541, filed on Apr. 18, 2022.

(30) Foreign Application Priority Data
May 14, 2021 (KR) 10-2021-0062897

(51) Int. Cl. B26B 21/52; B26B 21/40

(52) U.S. Cl. CPC B26B 21/521; B26B 21/4012

(57) ABSTRACT

A razor handle configured to be coupled to a razor cartridge is proposed. The razor handle may include a holder and two first coupling portions of which at least a part is disposed in the holder, and which include a latching portion including a first surface extended in a direction perpendicular to a direction in which the razor handle is coupled to the razor cartridge, and a second surface extended while being inclined inwardly forward from an end of the extended first surface. The razor handle may also include a detaching member configured to adjust a distance between the two first coupling portions, which has a first position in which the distance between the two first coupling portions is a first distance and a second position in which the distance between the two first coupling portions is a second distance shorter than the first distance.

### CROSS-REFERENCE TO RELATED APPLICATION

This is a continuation application of International Patent Application No. PCT/KR2022/005541, filed on Apr. 18, 2022, which claims priority to Korean Patent Application No. 10-2021-0062897 filed on May 14, 2021, the disclosure of each of which is incorporated by reference herein in its entirety.

### BACKGROUND

### Technical Field

The present disclosure relates to a razor handle.

### Description of Related Technology

Contents described in this section merely provide background information on the present disclosure and do not constitute the prior art.

In general, a razor assembly known as a wet razor includes a razor cartridge and a razor handle.

### SUMMARY

One aspect is to make a position of a pivot axis be adjacent to a foremost shaving blade.

Another aspect is a razor handle which does not have a separate pivoting structure and has high durability.

Another aspect is a razor handle configured to be coupled to a razor cartridge, comprising: a holder; two first coupling portions of which at least a part is disposed in the holder, and which include a latching portion including a first surface extended in a direction perpendicular to a direction in which the razor handle is coupled to the razor cartridge, and a second surface extended while being inclined inwardly forward from an end of the extended first surface; and a detaching member configured to adjust a distance between the two first coupling portions, which has a first position in which the distance between the two first coupling portions is a first distance and a second position in which the distance between the two first coupling portions is a second distance shorter than the first distance.

As described above, according to the embodiment, there is an effect in that the razor handle can provide an improved pivoting function, and moreover, can reduce the size of the razor cartridge.

Further, there is an effect in that the razor handle can provide a coupling structure having high durability.

### BRIEF DESCRIPTION OF THE DRAWINGS

FIG. 1 is a perspective view of a razor assembly according to an embodiment of the present disclosure.

FIG. 2 is a bottom perspective view of a razor assembly according to an embodiment of the present disclosure.

FIG. 3 is an exploded perspective view of the razor assembly according to an embodiment of the present disclosure.

FIG. 4 is a plan view of a razor handle according to an embodiment of the present disclosure.

FIG. 5 is a diagram illustrating a state in which a razor cartridge of FIG. 3 is separated from the razor handle.

FIG. 6 is a bottom view of the razor assembly according to an embodiment of the present disclosure.

FIG. 7 is a bottom view of the razor assembly according to another embodiment of the present disclosure.

FIGS. 8A to 8D are diagrams illustrating a process in which the razor cartridge is coupled to and separated from the razor handle according to an embodiment of the present disclosure.

FIGS. 9A and 9B are diagrams illustrating a state in which the razor cartridge pivots according to an embodiment of the present disclosure.

### DETAILED DESCRIPTION

The razor cartridge is configured to be pivotable about the razor handle between a rest position and a pivoting position which deviates from the rest position. A pivoting motion of the razor cartridge is basically made about a pivot axis parallel to an alignment direction of a shaving blade.

The pivoting motion of the razor cartridge about the pivot axis parallel to the alignment direction of the shaving blade allows the shaving blade to smoothly contact a skin of a user to assist efficient shaving.

In order to implement such a pivoting motion of the razor cartridge, the conventional razor assembly adopts a pivoting connecting type or a fixed connecting type. In the pivoting connecting type, a connector is configured to be fixed with respect to the razor handle and to be pivotable about the pivot axis with respect to the razor cartridge. In the fixed connecting type, the connector is configured to be fixed with respect to the razor cartridge and to be pivotable about the pivot axis with respect to the razor handle.

The pivoting connecting type has an effect in which a position of the pivot axis is made to be adjacent to a position of a foremost shaving blade to provide a more improved pivoting function. However, the pivoting connecting type has a problem in that a size of a razor cartridge which needs to be replaced after being during a predetermined period or at a predetermined number of times increases.

The fixed connecting type has an advantage in that since the connector is fixed to the razor cartridge, the size of the razor cartridge becomes relatively smaller than that in the pivoting connecting type. However, the fixed connecting type has a problem in that since the pivoting function is provided in the razor handle, a structure of the razor handle becomes complicated, and as a result, durability of the razor handle deteriorates.

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Additionally, various ordinal numbers or alpha codes such as first, second, i), ii), a), b), etc., may be prefixed. These numbers and codes are solely used to differentiate one component from the other but not to imply or suggest the substances, order, or sequence of the components. Throughout this specification, when a part “includes” or “comprises” a component, the part is meant to further include other components, not to exclude thereof unless specifically stated to the contrary.

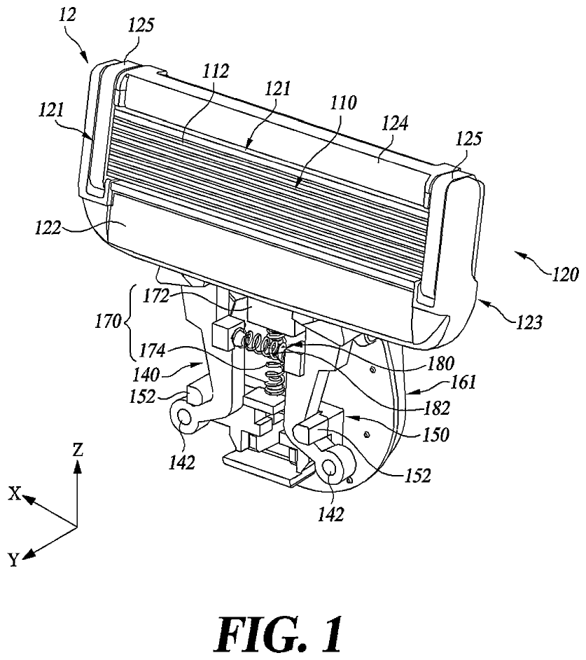

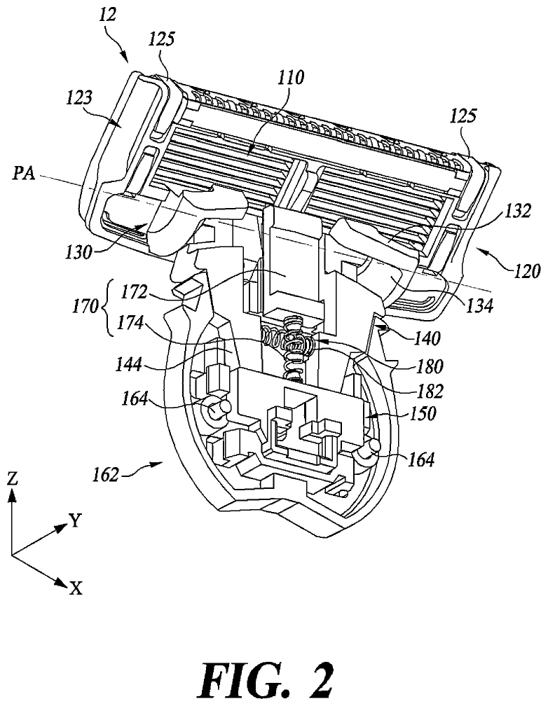

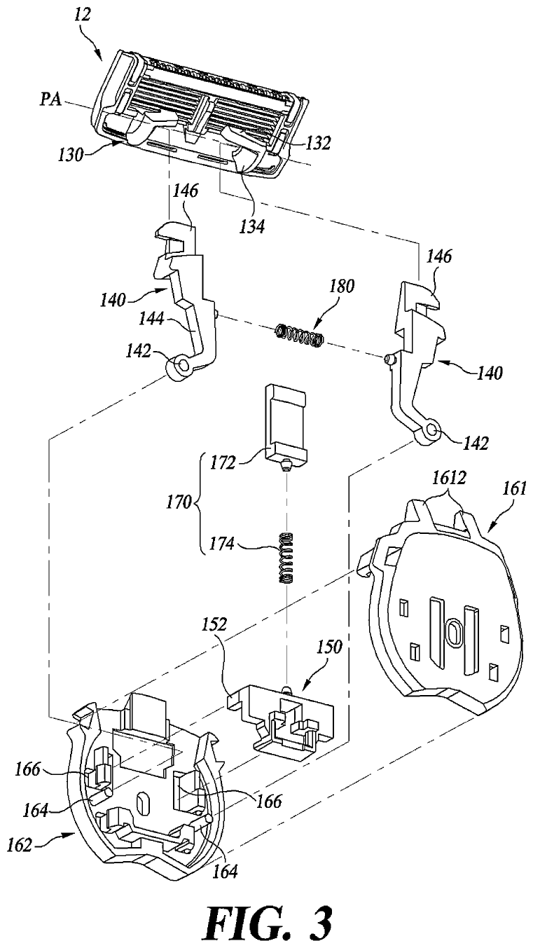

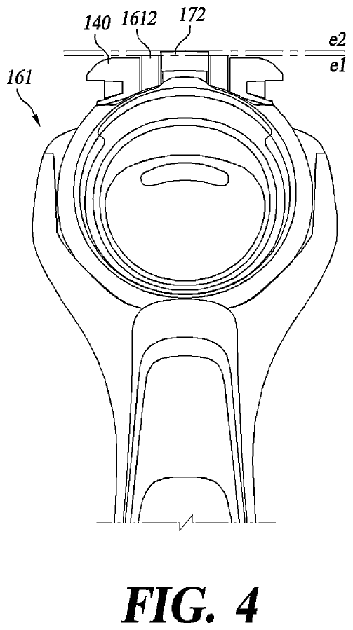

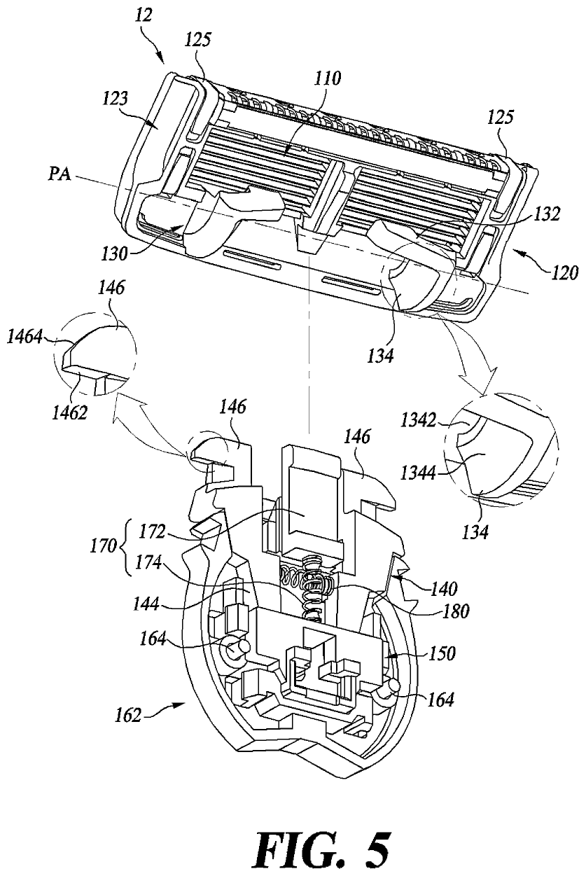

FIG. 1 is a perspective view of a razor assembly according to an embodiment of the present disclosure. FIG. 2 is a bottom perspective view of the razor assembly according to an embodiment of the present disclosure. FIG. 3 is an exploded perspective view of a razor assembly according to an embodiment of the present disclosure. FIG. 4 is a plan view of a razor handle according to an embodiment of the present disclosure. FIG. 5 is a diagram illustrating a state in which a razor cartridge of FIG. 2 is separated from the razor handle. For convenience of description, FIG. 1 and FIG. 2 are illustrated while a lower holder 162 and an upper holder 161 are omitted, respectively.

Referring to FIGS. 1 to 5, the razor assembly includes a razor cartridge 12, a connector 130, and a razor handle. The razor cartridge 12 may include at least one shaving blade 110 and a blade housing 120.

At least one shaving blade 110 may have a cutting edge 112 for cutting the hair.

The blade housing 120 may accommodate at least one shaving blade 110 to be placed in a longitudinal direction. Herein, the longitudinal direction as a direction parallel to an X axis refers to a direction in which the shaving blade 110 is extended.

At least one shaving blade 110 may be held by a plurality of clips 125 while being accommodated in one side of the blade housing 120.

The blade housing 120 may include an upper surface 121, a lower surface 123, a blade guard 122, and a cap 124.

The upper surface 121 may be a surface of the blade housing 120 faced by the cutting edge 112, and the lower surface 123 may be a surface of the blade housing 120 opposite to the upper surface 121.

On the upper surface 121 of the blade housing 120, the blade guard 122 may be located in front of the shaving blade 1110, and the cap 124 may be located in the rear of the shaving blade 110. Herein, in the razor cartridge 12, ‘the front of the shaving blade’ and ‘the rear of the shaving blade’ are defined based on a shaving direction of the razor cartridge 12.

The blade guard 122 may stretch the skin in the shaving direction before cutting the hair by the shaving blade 110 upon shaving.

Through this, the hair of a user may be erected in a direction perpendicular to a skin surface of the user, and as a result, the shaving blade 110 may more easily cut the hair.

The connector 130 may be fixed to one side of the blade housing 120. For example, the connector 130 may be manufactured as a separate member from the blade housing 120, and then mounted and fixed onto the blade housing 120, in order to solidify coupling between the connector 130 and the razor handle. In this case, the connector 130 may be fixed to at least a portion of the lower surface 123 of the blade housing 120, other than a region in which the at least one shaving blade 110 is disposed, and preferably fixed to the front of the shaving blade 110.

Alternatively, the connector 130 may be extended from one side of the blade housing 120, and manufactured integrally with the blade housing 120. Even in this case, the connector 130 may be injected from at least a partial region among the remaining regions other than the region in which the shaving blade 110 is disposed, on the lower surface 123 of the blade housing 120, and preferably located in the front of the shaving blade 110.

The connector 130 is configured to be coupled to a first coupling portion 140 provided in the razor handle, and includes a second coupling portion 134 having a third surface 1342 configured to face a first surface 1462 of the first coupling portion 140. Further, the second coupling portion 134 has an receiving portion 136 configured to receive at least a part of the first coupling portion 140. Specifically, a concave portion 1362 in which a latching portion 146 of the first coupling portion 140 may be received is formed in the receiving portion 136. The receiving portion 136 receives the first coupling portion 140, and the first surface 1462 and the third surface 1342 face to stably couple the razor handle and the razor cartridge 12.

Two first coupling portions 140 may be provided, and the connector 130 may have open regions for the two first coupling portions 140 to enter, respectively. Two second coupling portions 134 may be provided in the connector 130, which correspond to the two first coupling portions 140. When the connector 130 and the razor handle are coupled, the two first coupling portions 140 are enabled to enter through the open region between the two second coupling portions 134. In this case, a plunger guard 1612 to be described below may also be located in the open region.

A fourth surface 1344 is formed in the rear of the third surface 1342 of the second coupling portion 134. The fourth surface 1344 has a predetermined inclined angle with respect to an axis perpendicular to the lower surface of the blade housing 120. Herein, the predetermined inclined angle may be 20 to 80 degrees, and preferably may be 40 to 50 degrees.

When the razor handle enters within a predetermined angle range which is a range in which the razor cartridge 12 may pivot with respect to the razor handle, the second coupling portion 134 may be formed to facilitate coupling to the razor cartridge 12 regardless of an entrance angle. To this end, the fourth surface 1344 of the second coupling portion 134 may have a predetermined inclined angle with respect to the axis perpendicular to the lower surface of the blade housing 120, and at the same time, may be extending from the lower surface of the blade housing 120 to a stop surface.

A cross-section of the fourth surface 1344 cut by any virtual plane including an entrance direction of the first coupling portion 140 which enters within the predetermined angle range, and a pivot axis PA may be formed to be closer to a center of the connector 130 toward the lower surface of the blade housing 120. As a result, when the entrance direction of the first coupling portion 140 is within the predetermined angle range, the second surface 1464 and the fourth surface 1344 may be formed to be cam-actuated with each other regardless of the entrance direction.

The connector 130 may include two stop surfaces 132 extended generally in the vertical direction to the lower surface of the blade housing 120. Herein, extending generally in the vertical direction means that the stop surface 132 need not particularly be perpendicular to the lower surface of the blade housing 120. For example, the stop surface 132 may be formed at an angle of 80 to 110 degrees from the lower surface of the blade housing 120.

When the razor cartridge 12 pivots about the pivot axis PA, the stop surface 132 is formed to prevent the two first coupling portions 140 from being damaged due to a received excessive external force, and define a pivot range of the razor handle with respect to the razor cartridge 12. The two stop surfaces 132 do not need to be particularly provided as illustrated in the drawing.

The connector 130 may be extended from the lower surface of the blade housing 120 in at least a partial region among the remaining regions other than a region in which at least one shaving blade 110 is disposed, on the lower surface 123 of the blade housing 120, and extended generally in the vertical direction. That is, the connector 130 may be disposed at a position which does not overlap with a washing region of the blade housing 120, and preferably, may be disposed in front of the shaving blade 110. Due to such disposition characteristics, there is an effect in that when the user washes the shaving blade 110 with water, etc., washing is not interrupted by the connector 130, and a stable and effective pivot axis is provided upon shaving.

The razor handle includes all or some of holders 161 and 162, the first coupling portion 140, a first restoring force providing portion 170, a second restoring force providing portion 180, and a detaching member 150.

The holders 161 and 162 are made by the coupling of an upper holder 161 and a lower holder 162. An empty space is formed inside the holders 161 and 162. The first coupling portion 140, the first restoring force providing portion 170, the second restoring force providing portion 180, and the detaching member 150 may be at least partially disposed inside the holders 161 and 162. The holders 161 and 162 may be separately manufactured, and then coupled to the razor handle, or may also be a partial component of the razor handle which is integrally formed in front of the razor handle.

An insertion protrusion 164 may be formed in the lower holder 162 so that a part of the first coupling portion 140 may be inserted. While an insertion groove 142 formed at a rear end of the first coupling portion 140 is inserted into the insertion protrusion 164, the insertion protrusion 164 may serve as an axis when the first coupling portion 140 moves. The insertion protrusion 164 may be formed in a cylindrical shape not to interrupt the movement of the first coupling portion 140. However, the present disclosure is not limited thereto, and in respect to a shape and a disposition of the insertion protrusion 164, it is enough that the insertion protrusion 164 is formed and disposed so that the first coupling portion is enabled to perform a pivoting motion about the axis with respect to the lower holder 162. For example, the insertion groove 142 may be formed in the lower holder 162, and the insertion protrusion 164 may be formed in the first coupling portion 140.

One or more plunger guards 1612 may be formed which are extended from one side of the upper holder 161, and disposed at inner upper portions of the two first coupling portions 140. That is, the plunger guard 1612 may be extended forward from the holders 161 and 162 to be disposed between the two first coupling portions 140.

The plunger guard 1612 may be extended from one side of the upper holder 161, and integrally formed, but is not limited thereto, and the plunger guard 1612 may be extended to one side of the lower holder 162, or extended from both the upper holder 161 and the lower holder 162 or the plunger guard 1612 may be separately manufactured, and formed by a type of coupling the plunger guard 1612 to the upper holder 161 or the lower holder 162.

In this case, as illustrated in FIG. 4, the plunger guard 1612 is preferably formed for a front end edge e1 of the plunger guard 1612 not to protrude more forward than a front end edge e2 of a plunger 172.

Alternatively, the front end edge e1 of the plunger guard 1612, the front end edge e2 of the plunger 172, and a front end edge of the first coupling portion 140 may be disposed substantially on the same line. Herein, the same line is a line parallel to the pivot axis PA.

The plunger 172 of the first restoring force providing portion 170 may be disposed between two plunger guards 1612. That is, the two plunger guards 1612 may be disposed at a left side of the plunger 172 and a right side of the plunger 172, respectively based on a protruding direction of the plunger 172. The plunger 172 is disposed between the two plunger guards 1612 to protect the plunger 172 from a stimulus such as an external foreign substance, etc., and serve to guide a motion direction of the plunger 172. In FIG. 3, the two plunger guards 1612 are provided, and formed to be symmetric based on an intermediate point parallel to a Z axis of the upper holder 161, but the present disclosure is not limited thereto. The plunger 172, the plunger guard 1612, and the first coupling portion 140 are all disposed to be adjacent to each other to form one unit at a front end of the razor handle, and when the razor cartridge 12 and the razor handle are coupled to each other, one unit may simultaneously enter the connector 130.

The plunger guard 1612 is not disposed on the same plane as a path in which the two first coupling portions 140 move. Therefore, when the two first coupling portions 140 move, the plunger guard 1612 does not interrupt the movement. Further, at least a part of the plunger guard 1612 provides a guide for movement of the two first coupling portions 140 to provide a stability to the movement of the first coupling portion 140. Specifically, when the two first coupling portions 140 move to be close to each other, a part of a y axis-direction (see FIG. 1) surface of the plunger guard 1612 is in contact with the two first coupling portions 140 to guide a movement path of the first coupling portion 140.

The plunger guard 1612 may be formed in a tapered shape in which a y axis-direction thickness decreases forward. That is, a lateral surface of the plunger guard 1612 may have a triangular cross-section. Even when the razor cartridge 12 is pivoted at a maximum angle while the plunger guard 1612 becomes thinner forward, a region for washing the shaving blade 110 may be preserved, and there is an advantage in that the razor cartridge 12 may be pivoted at a larger angle as compared with a case where the plunger guard 1612 is extended with a predetermined thickness.

Further, due to such a layout structure, in a state in which the plunger guard 1612 is coupled to the razor cartridge 12, the two first coupling portions 140 may be protected. That is, the plunger guard 1612 is added to prevent the plunger 172 of which a part is protruded from the holders 161 and 162, and the two first coupling portions 140 from being damaged.

When the two second coupling portions 134 are disposed to be completely spaced apart from each other, the plunger guard 1612 may be disposed to be placed in a space between the two second coupling portions 134. Further, according to the present disclosure, a shape of the space between the two second coupling portions 134 and a shape of the front end of the plunger guard 1612 are made to correspond to each other to increase a visibility for an appropriate coupling point of the first coupling portion 140 and the second coupling portion 134.

A component which performs a similar function to the plunger guard 1612 may formed in the connector 130 of the razor cartridge 12 instead of the holders 161 and 162.

The razor cartridge 12 is a component which needs to be continuously replaced, while the razor handle is a component which may be continuously used unless there is a special situation. There is an effect of lowering a manufacturing price when forming the plunger guard 1612 in the upper holder 161 which is a partial component of the razor handle than adding the component such as the plunger guard 1612 to all razor cartridges.

The first coupling portion 140 is configured to be at least partially disposed in the holders 161 and 162, and coupled to the receiving portion 136 which is the space formed inside the connector 130. At least a part of the two first coupling portions 140 is disposed in the holders 161 and 162, but the remaining is disposed to be protruded to the outside.

The first coupling portion 140 may be made of a plastic material. In particular, the first coupling portion 140 may be made of one material of PolyEther Ether Ketone (PEEK), PolyPhenylene Sulfide (PPS), and engineers plastics among plastics, and the present disclosure is not limited thereto.

The first coupling portion 140 may include the latching portion 146 configured to be coupled to the receiving portion 136. The latching portion 146 may include a first surface 1462 extended in a direction perpendicular to a direction in which the razor handle is coupled to the razor cartridge, and a second surface 1464 extended while being inclined inwardly forward from an end of the extended first surface 1462. An extension direction of the first surface 1462 may be parallel to the direction of the pivot axis PA.

Herein, an inclined angle of a slope formed by the second surface 1464 is preferably formed to correspond to an inclined angle formed by a surface of the razor cartridge 12 which is in contact with the second surface 1464, specifically, the fourth surface 1344 when the first coupling portion 140 is coupled to the razor cartridge 12.

The latching portion 146 may have a fan-shaped cross-section.

A distance between the two first coupling portions 140 is adjusted to mount/demount the razor handle and the razor cartridge 12. The two first coupling portions 140 may move from a first position to a second position. Herein, the first position means positions of the two first coupling portions 140 when longitudinal distances of the two first coupling portions 140 are a first distance, and the second position means positions of the two first coupling portions 140 when the longitudinal distances of the two first coupling portions 140 are a second distance shorter than the first distance.

When no external force is applied to the two first coupling portions 140, the two first coupling portions 140 are located at the first position by an elastic force of the second restoring force providing unit 180 to be described below. The pivot axis PA may be formed by passing the front end of the latching portion 146. Further, the pivot axis PA may be disposed between the upper surface 121 of the blade housing 120 and the third surface 1342.

The first restoring force providing unit 170 is configured to restore the razor cartridge 12 to a rest position by cam-actuating with a partial region of the razor cartridge 12. That is, the first restoring force providing unit 170 is configured to provide a restoring force for restoring the razor cartridge 12 rotated about the pivot axis PA to the rest position. Herein, the rest position means a position formed when the external force is not applied to the razor cartridge 12 in the state in which the razor cartridge 12 and the razor handle are coupled.

The restoring force providing unit 170 may include the plunger 172 and a first elastic member 174. At least a part of the plunger 172 is configured to be protruded forward of the holders 161 and 162, and disposed between the two first coupling portions 140, and to transmit the restoring force by cam-actuating with at least a part of the razor cartridge 12. One end of the plunger 172 is disposed to be in contact with the razor cartridge 12 in the state in which the razor cartridge 12 and the razor handle are coupled. The other end of the plunger 172 is connected to the first elastic member 174.

The first elastic member 174 may be disposed inside the holders 161 and 162, and may provide the elastic force to the plunger 172. The first elastic member 174 may be a spring, but is not limited thereto. One side of the first elastic member 174 adjacent to the razor cartridge 12 is connected to the plunger 172, and the other side of the first elastic member 174 spaced apart from the razor cartridge 12 is connected to the detaching member 150.

Accordingly, when the razor cartridge 12 rotates about the pivot axis PA, the razor cartridge 12 compresses the first elastic member 174. The restoring force by elasticity is formed by a result of compressing the first elastic member 174.

The second restoring force providing unit 180 is configured to provide the restoring force for restoring the two first coupling portions 140 which move to the second position to the first position. Referring to FIGS. 1 to 3, the second restoring force providing unit 180 includes a second elastic member 182 configured to be disposed between the two first coupling portions 140, and provide the elastic force. The second elastic member 182 may be the spring, but is not limited thereto.

One side of the second elastic member 182 is connected to one first coupling portion 140, and the other side is connected to the other one first coupling portion 140. The second elastic member 182 may be disposed to provide the elastic force in the longitudinal direction between the two first coupling portions 140.

When the distance between the two first coupling portions 140 decreases, that is, when the two first coupling portions move from the first position to the second position, the second elastic member 182 is compressed to provide the elastic force in a direction in which the two first coupling portions 140 are far away from each other. Accordingly, the two first coupling portions 140 are moved to the second position by an external influence, and then when the external influence is removed, the two first coupling portions 140 are restored to the first position again due to the elastic force of the second elastic member 182.

The detaching member 150 is configured to adjust the distance between the two first coupling portions 140. The detaching member 150 may include two pressing protrusions 152. The two pressing protrusions 152 of the detaching member 150 press pressing surfaces 144 of the two first coupling portions 140 to move the two first coupling portions 140 to the second position. Accordingly, when the detaching member 150 moves to the front in the state in which the razor cartridge 12 is coupled to the razor handle, the latching portion 146 of the first coupling portion 140 is separated from the receiving portion 136.

The lower holder 162 may include a rail groove 166 formed so that the pressing protrusion 152 is inserted into one surface thereof and so as to guide movement to the front or the rear of the pressing protrusion 152. While the detaching member 150 moves to the front, the pressing protrusion 152 moves to the front along the rail groove 166.

The rail groove 166 may be formed with a length in a direction extended toward the front perpendicular to the longitudinal direction. That is, the rail groove 166 may be formed in the form of a groove extended in the direction parallel to the Z axis. In FIG. 3, the rail groove 166 is formed in a rectangular shape, but is not limited thereto. For example, both Z axis-direction ends of the rail groove 166 may also have a shape of a curve.

The pressing protrusion 152 is disposed to press the pressing surface 144 of the first coupling portion 140 while moving in a positive Z-axis direction along the rail groove 166. As the pressing protrusion 152 presses the pressing surface 144, the distance between the two first coupling portions 140 decreases. That is, as the pressing protrusion 152 presses the pressing surface 144, the two first coupling portions 140 move to the second position. When the pressing protrusion 152 moves in a negative Z-axis direction along the rail groove 166, the distance between the two first coupling portions 140 increases by the second restoring force providing unit 180. The distance between the two first coupling portions 140 may be adjusted according to the position of the pressing protrusion 152 in the rail groove 166.

Referring to FIG. 5, the latching portion 146 of the first coupling portion 140 may include the first surface 1462 and the second surface 1464 formed in a forward direction of the first surface 1462. The second coupling portion 134 may include the third surface 1342 and the fourth surface 1344 formed in a rear direction of the third surface 1342. Two fourth surfaces 1344 illustrated in FIG. 5 may have a symmetric shape based on a center of a width direction perpendicular to the longitudinal direction.

The first surface 1462 and the third surface 1342 are configured to face each other when the first coupling portion 140 of the razor handle is coupled to the second coupling portion 134 of the razor cartridge 12. When the razor cartridge 12 or the connector 130 rotates with respect to the razor handle about the pivot axis PA, the first surface 1462 and the third surface 1342 are configured so that the first surface 1462 moves with respect to the third surface 1342 along the third surface 1342. The first surface 1462 is disposed to be closer to the pivot axis PA than to the third surface 1342. Since the pivot axis PA passes a free end of the first coupling portion 140, i.e., a front-side end, the first surface 1462 is disposed to be closer to the pivot axis PA than to the third surface 1342.

The first surface 1462 and the third surface 1342 may be formed as a curved surface. In this case, the third surface 1342 may have a concave curved surface, and the first surface 1462 may have a convex curved surface corresponding to the concave curved surface of the third surface 1342. The curved surface of the first surface 1462 and the curved surface of the third surface 1342 may have a profile of an arc about the pivot axis PA. Alternatively, a curvature of the first surface 1462 may be formed to correspond to the curvature of the third surface 1342. The first surface 1462 should not particularly have the curved surface or the curvature of the first surface 1462 should not particularly correspond to the curvature of the third surface 1342. For example, the first surface 1462 may have a straight surface. The first surface 1462 may have the straight surface, and move with respect to the third surface 1342 having the curved surface when the razor cartridge 12 pivots.

The second surface 1464 may cam-actuate with the fourth surface 1344 to enter the receiving portion 136 in the second coupling portion 134 in a process in which the first coupling portion 140 and the second coupling portion 134 are coupled to each other. The fourth surface 1344 is formed to cam-actuate with the second surface 1464 regardless of the entrance angle when the first coupling portion 140 is coupled to the second coupling portion 134.

That is, within a predetermined angle range in which the razor cartridge 12 is pivotable within the concave portion 1362 of the second coupling portion 134, the first coupling portion 140 may be coupled by cam-actuation of the second surface 1464 and the fourth surface 1344 even though the first coupling portion 140 enters in any direction. When an initial pivot angle of the razor cartridge 12 is set to 0 degree, herein, the predetermined angle range may be 0 to 90 degrees, and preferably may be 0 to 50 degrees. This reduces a hassle in which the user explores the entrance direction when newly coupling the razor cartridge 12 in order to replace the razor cartridge 12.

Further, the second surface 1464 and the fourth surface 1344 are formed at angles corresponding to each other as described above, so while the first coupling portion 140 is coupled to the razor cartridge 12 to cam-actuate with the razor cartridge 12, a predetermined contact area may be maintained between the second surface 1464 and the fourth surface 1344.

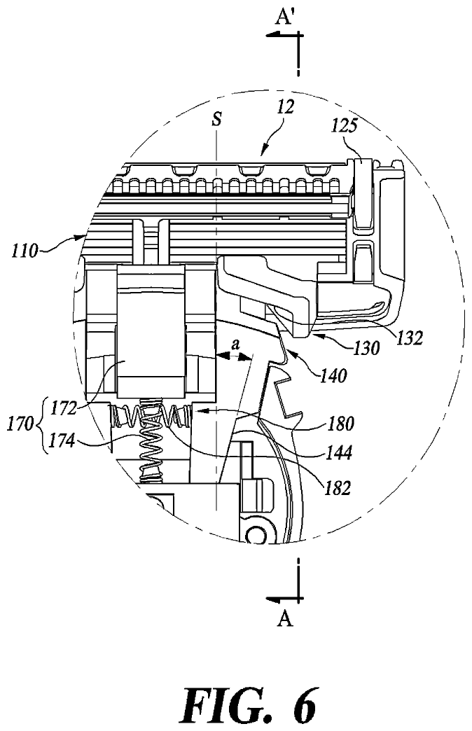

FIG. 6 is a bottom view of the razor assembly according to an embodiment of the present disclosure.

Referring to FIG. 6, any S axis is illustrated which is perpendicular to the pivot axis PA and parallel to the longitudinal direction of the rail groove 166. The pressing surface 144 of the first coupling portion 140 may be formed to be inclined at an angle a from the S axis. As a size of the angle a increases, a distance at which the first coupling portion 140 is pressed increases when the pressing protrusion 152 moves in the forward direction along the rail groove 166.

As described above, according to the present disclosure, when the first coupling portion 140 is manufactured, the angle a of the pressing surface 144 is adjusted to adjust a maximum distance at which the first coupling portion 140 may be moved by the pressing protrusion 152. Further, the present disclosure may be configured to increase a maximum distance at which the first coupling portion 140 may move in the longitudinal direction by increasing the angle a of the pressing surface 144 without adding a separate component.

In order for the latching portion 146 of the first coupling portion 140 to be completely coupled to the connector 130, distances at which the two first coupling portions 140 move, respectively should be larger than B which is a length of the first surface 1462 of the latching portion 146. Accordingly, when a distance at which one first coupling portion 140 is movable is shorter than B, a length at which the latching portion 146 is coupled to the second coupling portion 134 of the connector 130 may not be sufficiently ensured, so it is difficult to stably couple the razor handle and the razor cartridge 12. That is, in order for the latching portion 146 to be completely coupled into the receiving portion, a sufficient movement distance of each of the two first coupling portions 140 should be ensured.

According to the present disclosure, a distance between the first position and the second position at which the two first coupling portions 140 may move may be increased due to technical features of the pressing surface 144 and the rail groove 166 described above.

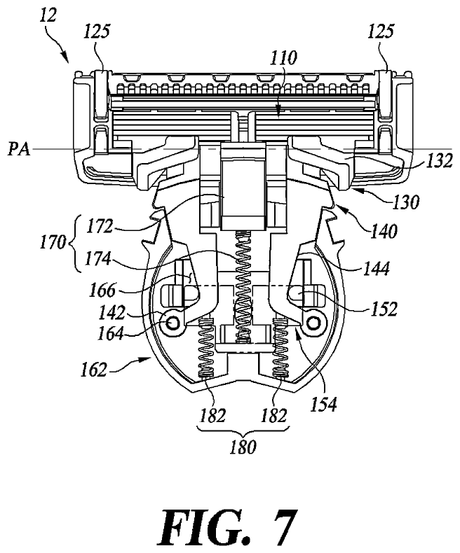

FIG. 7 is a bottom view of the razor assembly according to another embodiment of the present disclosure.

Referring to FIG. 7, the second restoring force providing unit 180 may include two second elastic members 182 connected to a part of a wall surface of the lower holder 162 and the two first coupling portions 140, respectively and providing the elastic force to respective first coupling portions 140. Two second restoring force providing units 180 should not particularly be in contact with the lower holder 162, and it is enough that one end of the second restoring force providing unit 180 may be fixed and disposed to one place.

In the case of FIG. 6, when one second elastic member 182 is connected between the two first coupling portions 140, and when the second elastic member 182 loses the elastic force as the second elastic member 182 is broken down or deviates from an original position, the second elastic member 182 may not provide the restoring force to both the two first coupling portions 140. On the contrary, according to another embodiment disclosed in FIG. 7, the two first coupling portions 140 is connected to the second elastic members 182, respectively one by one, so even though any one second elastic member 182 is broken down or loses the elastic force, the other one second elastic member 182 may provide the restoring force to the first coupling portion 140 corresponding thereto.

Further, in the case of FIG. 6, the first elastic member 174 and the second elastic member 182 may cause physical interference with each other while being compressed and expanded, but according to another embodiment disclosed in FIG. 7, the second elastic member 182 may be disposed to be spaced apart from the first elastic member 174 without the physical interference.

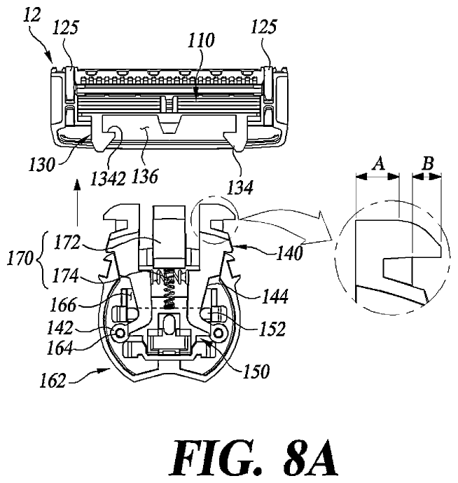

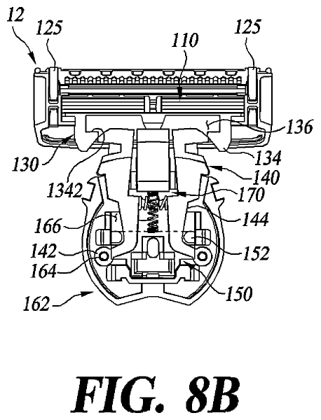

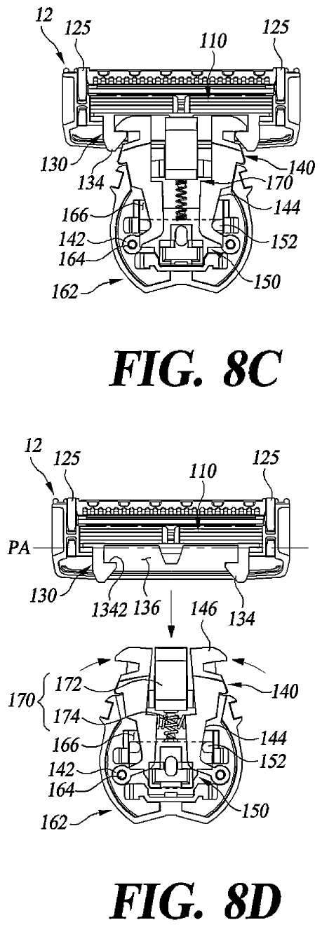

FIGS. 8A to 8D are diagrams illustrating a process in which the razor cartridge is coupled to and separated from the razor handle according to an embodiment of the present disclosure. For convenience of description, the upper holder 161 is omitted in the drawing. FIG. 8A is a diagram before the razor handle is coupled to the razor cartridge 12. FIG. 8B is a diagram in which the first coupling portion 140 cam-actuates with the second coupling portion 134 in the process in which the razor handle and the razor cartridge 12 are coupled. FIG. 8C is a diagram illustrating the state in which the razor handle is coupled to the razor cartridge 12. FIG. 8D is a diagram illustrating the state in which the razor handle is separated from the razor cartridge 12.

In an order of FIGS. 8A, 8B, and 8C, the razor handle is coupled to the razor cartridge 12.

Referring to FIG. 8A, an embodiment in which the razor handle enters the razor cartridge 12 is illustrated. A direction in which the razor handle enters the razor cartridge 12 is not defined as one as in FIG. 8A, and it is enough that the razor handle enters only in a direction within a predetermined angle range in which the razor cartridge 12 is pivotable. That is, in a razor assembly according to the present disclosure, when the razor handle is coupled to the razor cartridge 12, the user may easily couple the razor handle to the razor cartridge 12 without an effort of determining a coupling angle.

In FIG. 8A, the latching portion 146 part is enlarged and illustrated. Herein, a longitudinal length of a front end edge of the latching portion 146 is illustrated as A and a longitudinal length of the first surface 1462 is illustrated as B. Specifically, A means a part at the front end edge of the latching portion 146, which is parallel to the pivot axis PA. According to the present disclosure, the length of B is increased as compared with the prior art, and as a result, the first coupling portion 140 and the second coupling portion 134 may be more stably coupled. Further, part A is a part that directly supports the blade housing 120 when the razor cartridge 12 pivots, and part A is formed to be long to provide a more stable supporting force. A may be 2.5 mm or more and B may be 1.5 mm or more. Preferably, A may be 2.85 mm and B may be 1.74 mm.

Referring to FIG. 8B, a process is illustrated in which the second surface 1464 of the first coupling portion 140 cam-actuates with the fourth surface 1344 of the second coupling portion 134 in the process in which the razor handle enters the razor cartridge 12. However, the cam-actuation is not particularly required in the coupling process, and the user moves the two first coupling portions 140 to the second position by moving the detaching member 150 in the forward direction to locate the first coupling portions 140 within the receiving portion 136 without the cam actuation.

Referring to FIG. 8C, when the first coupling portion 140 is completely inserted into the receiving portion 136, a cam-actuation state between the second surface 1464 and the fourth surface 1344 may be released.

The second surface 1464 does not press the fourth surface 1344 any longer through the release of the cam actuation state, and as a result, the two first coupling portions 140 is restored to the first position by the elastic force of the second restoring force providing unit 180. When the two first coupling portions 140 are restored to the first position in the receiving portions 136 of the second coupling portion 134, the first surface 1462 of the first coupling portion 140 and the third surface 1342 of the second coupling portion 134 face each other, and as a result, the first coupling portion 140 and the second coupling portion 134 may be coupled to each other.

In this case, since the first surface 1462 and the third surface 1342 have shapes corresponding to each other, the first coupling portion 140 and the second coupling portion 134 may be further firmly coupled to each other. For example, the third surface 1342 may have the concave curved surface, and the first surface 1462 may have the convex curved surface corresponding to the concave curved surface of the third surface 1342.

Referring to FIG. 8D, the two first coupling portions 140 are moved to the second position by moving the detaching member 150 to the front to separate the razor handle and the razor cartridge 12. In this case, the detaching member 150 should be moved to the front enough for the first surface 1462 of the first coupling portion 140 to be spaced apart from the third surface 1342.

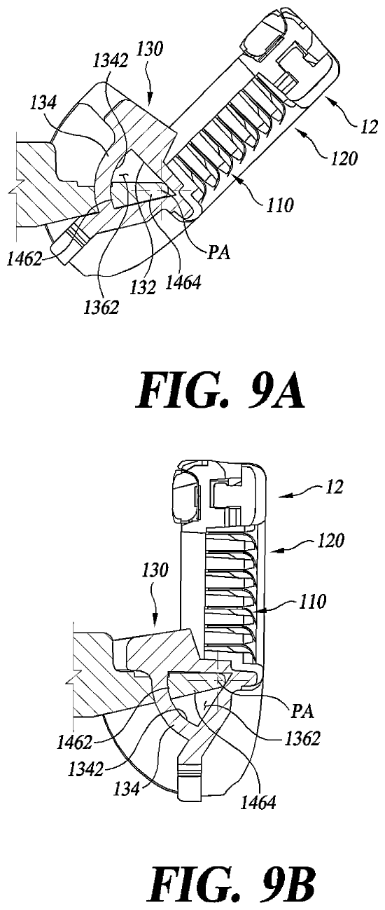

FIGS. 9A and 9B are diagrams illustrating a state in which the razor cartridge pivots according to an embodiment of the present disclosure. Specifically, FIGS. 9A and 9B illustrate transverse cross-sectional views of the razor assembly taken along direction A-A′ of FIG. 6. FIG. 9A is a diagram illustrating the rest position of the razor cartridge 12 and FIG. 9B a maximum pivoting position of the razor cartridge 12. The razor cartridge 12 is configured to pivot between the rest position and the maximum pivoting position by external force, and when the external force disappears, the pivoted razor cartridge 12 returns to the rest position by the restoring force supplied by the first restoring force providing unit 170.

Referring to FIG. 9A and 9B, the first surface 1462 may have the convex curved surface, and the third surface 1342 may have the concave curved surface corresponding to the convex curved surface of the first surface 1462. For smooth pivoting of the razor cartridge 12, the curved surface of the first surface 1462 and the curved surface of the third surface 1342 may have the profile of the arc about the pivot axis PA.

A concave portion 1362 is formed in the receiving portion 136 to receive the latching portion 146 of the first coupling portion 140. A cross-section of the concave portion 1362 may have a fan shape. The pivot axis PA may be disposed to pass the concave portion 1362. Specifically, the pivot axis PA may be disposed to pass an end of the concave portion 1362 toward the upper surface 121 of the blade housing 120. A cross-sectional shape of the latching portion 146 may also be the fan shape to correspond to the shape of the concave portion 1362. Herein, the fan shape does not particularly mean a shape formed by an arc linking two radii and two radius lines formed from a center of a circle, but means all shapes formed by two line segments and one curved surface. Further, the latching portion 146 may also have a triangular shape other than the fan shape. That is, if the latching portion 146 is pivotable within the concave portion 1362, the cross-section of the latching portion 146 need not particularly to have the fan shape.

The razor cartridge 12 may pivot between the rest position and the maximum pivoting position about the pivot axis PA. In this case, as illustrated in FIGS. 9A and 9B, the pivot axis PA is located at a place which passes the front end of the first coupling portion 140 to enable close shaving for the curved skin surface. That is, the pixel axis PA is made to be located closer to the upper surface 121 of the blade housing 120, and may be further close to a foremost shaving blade of the at least one shaving blade 110, so the razor assembly may implement a more improved pivoting function.

When the razor cartridge 12 is located at the maximum pivoting position, the first coupling portion 140 is in contact with the stop surface 132. This is to prevent the first coupling portion 140 from being damaged when an excessive external force which makes the razor cartridge 12 move more than the maximum pivoting position is applied to the razor cartridge 12. That is, when the first coupling portion 140 is located at the maximum pivoting position, force applied to the first coupling portion 140 is dispersed by maximizing an area of the upper surface of the first coupling portion 140 which is in contact with the stop surface 132 to prevent the first coupling portion 140 from being damaged, and the razor cartridge 12 is restricted to pivot over an allowed pivot angle to prevent the second coupling portion 134 from being separated from the first coupling portion 140 of the razor handle.

Although exemplary embodiments of the present disclosure have been described for illustrative purposes, those skilled in the art will appreciate that various modifications, additions, and substitutions are possible, without departing from the defining features by the embodiments. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A razor handle configured to be coupled to a razor cartridge, comprising:
a holder;
two first coupling portions, at least a part of the two first coupling portions disposed in the holder, the two first coupling portions comprising:
a latching portion including a first surface extended in a direction perpendicular to a direction in which the razor handle is coupled to the razor cartridge, and a second surface extended while being inclined inwardly forward from an end of the extended first surface; and
a detaching member configured to adjust a distance between the two first coupling portions, the detaching member having a first position in which the distance between the two first coupling portions is a first distance and a second position in which the distance between the two first coupling portions is a second distance shorter than the first distance.

2. The razor handle of claim 1, wherein the latching portion has a fan-shaped cross-section.

3. The razor handle of claim 1, wherein the razor cartridge includes a third surface configured to face the first surface, and
wherein in response to the razor cartridge pivoting with respect to the holder, the first surface is configured to move with respect to the third surface along the third surface.

4. The razor handle of claim 2, wherein in a state in which the razor cartridge is coupled to the first coupling portion, a pivot axis is formed which passes a front end of the latching portion.

5. The razor handle of claim 4, further comprising:
a first restoring force providing unit configured to provide a restoring force for restoring the razor cartridge rotated about the pivot axis to a rest position.

6. The razor handle of claim 5, wherein the first restoring force providing unit includes:
a plunger of which at least a part protrudes forward of the holder, and which is configured to be disposed between the two first coupling portions, and transmit the restoring force by cam-actuating with at least a part of the razor cartridge, and
a first elastic member configured to provide an elastic force to the plunger.

7. The razor handle of claim 6, wherein one side of the first elastic member adjacent to the razor cartridge is connected to the plunger, and the other side of the first elastic member spaced apart from the razor cartridge is connected to the detaching member.

8. The razor handle of claim 6, further comprising:
a plunger guard extended forward from the holder to be disposed between the two first coupling portions.

9. The razor handle of claim 8, wherein a front end edge of the plunger guard does not protrude forward beyond the front end edge of the plunger.

10. The razor handle of claim 8, comprising:
two plunger guards extended from the holder,
wherein the two plunger guards are disposed at a left side of the plunger and a right side of the plunger, respectively based on a protruding direction of the plunger.

11. The razor handle of claim 1, wherein a inclined angle of the second surface corresponds to an inclined angle formed by a surface of the razor cartridge, which is in contact with the second surface when the first coupling portion is coupled to the razor cartridge.

12. The razor handle of claim 1, further comprising:
a second restoring force providing unit configured to provide the restoring force for restoring the two first coupling portions which move to the second position to the first position.

13. The razor handle of claim 12, wherein the second restoring force providing unit includes a second elastic member configured to be disposed between the two first coupling portions, and provide an elastic force.

14. The razor handle of claim 12, wherein the second restoring force providing unit includes two second elastic members connected to a part of a wall surface of the holder, and the two first coupling portions, respectively, and providing an elastic force to each first coupling portion.

15. The razor handle of claim 1, wherein the two first coupling portions comprise pressing surfaces formed in the rear of the first surface,
wherein the detaching member comprises a pressing protrusion configured to press the pressing surface, and
wherein the pressing protrusion is configured to press the pressing surface, so the distance between the two first coupling portions is changed.

16. The razor handle of claim 15, wherein the holder further includes a rail groove formed so that the pressing protrusion is inserted into one surface of the holder and the pressing protrusion moves forward and backward.
